(19) United States
(12) Patent Application Publication
(10) Pub. No.: US 2026/0111843 A1
(43) Pub. Date: Apr. 23, 2026

(54) SYSTEM

(71) Applicant: SoftBank Group Corp., Tokyo (JP)

(72) Inventor: Toshihide DOI, Tokyo (JP)

(21) Appl. No.: 19/353,676

(22) Filed: Oct. 9, 2025

(30) Foreign Application Priority Data
Oct. 18, 2024 (JP) 2024-183669

(51) Int. Cl. G06Q 10/10; G06N 3/0475; G06V 20/40; G06V 40/20

(52) U.S. Cl. CPC G06Q 10/10; G06N 3/0475; G06V 20/41; G06V 20/44; G06V 40/20

(57) ABSTRACT

The system according to the embodiment includes an analysis unit, a generation unit, a creation unit, and a support unit. The analysis unit analyzes a video. The generation unit generates images and descriptive text based on the content of the video analyzed by the analysis unit. The creation unit creates a manual based on the images and descriptive text generated by the generation unit. The support unit provides a chatbot that responds to the manual created by the creation unit.

### CROSS-REFERENCE TO RELATED APPLICATION

The present application claims priority to and incorporates by reference the entire contents of Japanese Patent Application No. 2024-183669 filed in Japan on Oct. 18, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that the creation of manuals requires a large amount of man-hours and is difficult for first-time users to understand.

### SUMMARY OF THE INVENTION

The system according to the embodiment includes an analysis unit, a generation unit, a creation unit, and a support unit. The analysis unit analyzes a video. The generation unit generates images and descriptive text based on the content of the video analyzed by the analysis unit. The creation unit creates a manual based on the images and descriptive text generated by the generation unit. The support unit provides a chatbot that responds to the manual created by the creation unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,”the same concept as “A and/or B”applies.

### First Embodiment

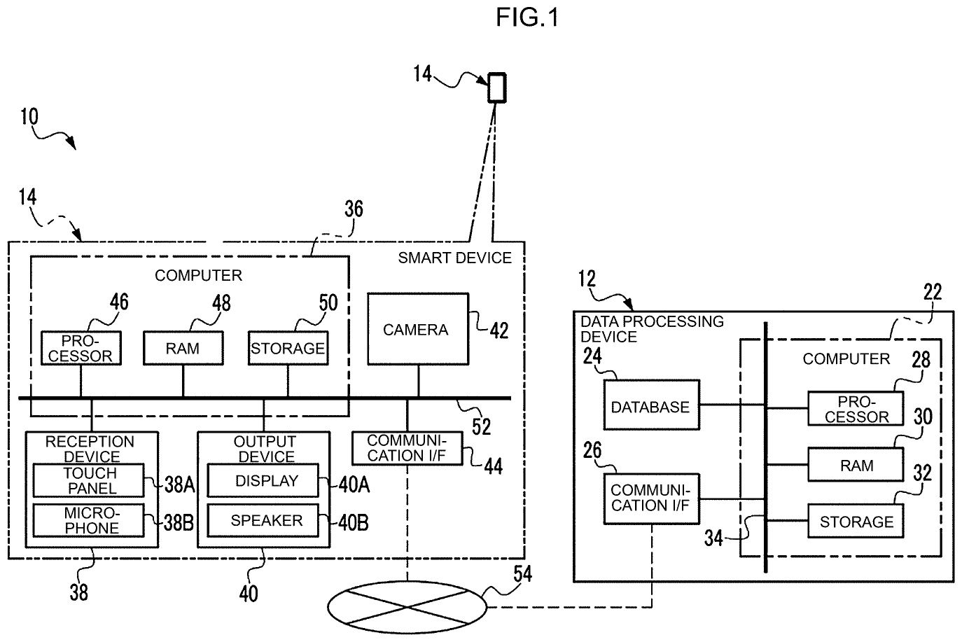

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

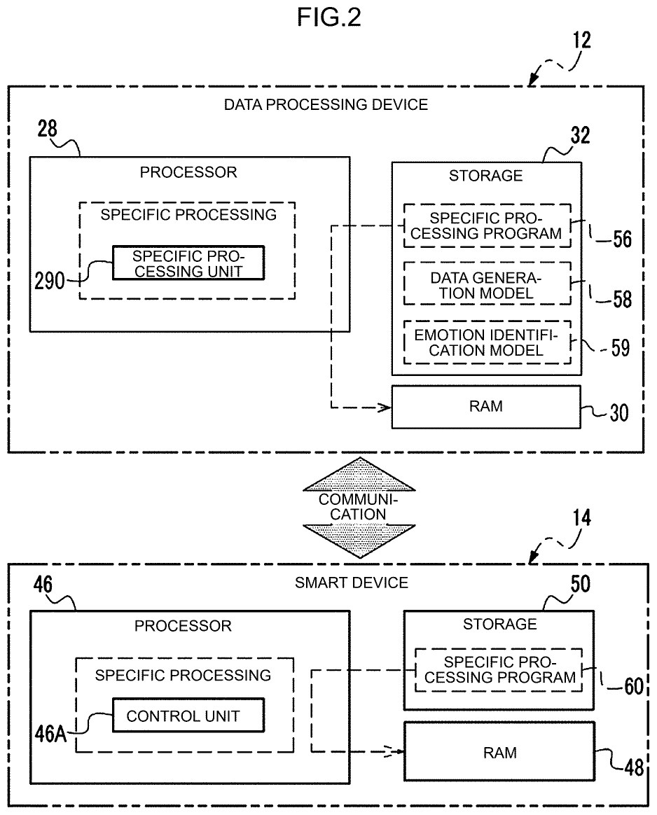

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The manual creation system according to the embodiment of the present invention is a system that automatically creates a manual based on video-recorded data. This manual creation system uses generative AI to generate images and text, instantly creating a manual that is easy for anyone to understand. In addition, by providing a chatbot that responds to the manual, more detailed understanding can be obtained. The manual creation system according to the embodiment of the present invention is a system that automatically creates a manual based on video-recorded data. This system uses generative AI to generate images and text, instantly creating a manual that is easy for anyone to understand. Furthermore, by providing a chatbot that responds to the manual, more detailed understanding can be obtained. First, the user records a video. This video is input to the generative AI. The generative AI analyzes the content of the video and generates images and descriptive text for each step. For example, when a video of machine operation procedures is input to the generative AI, the generative AI generates images and descriptive text for each operation step. Next, a manual is automatically created based on the images and descriptive text generated by the generative AI. The generated manual is structured to be easy to understand even for first-time users. For example, the images and descriptive text for each step are arranged in order, making the operation procedure immediately understandable. Furthermore, the generated manual is provided with a chatbot. When the user asks a question about the content of the manual, the chatbot provides an answer. For example, if a question is asked about a specific operation procedure, the chatbot provides a detailed explanation of that procedure. With this mechanism, the man-hours required for manual creation are greatly reduced, and version control is also facilitated. Since the generative AI automatically creates the manual, the latest manual is always provided. In addition, since a chatbot is provided, answers to unclear points can be obtained immediately. For example, in the manufacturing industry, when manualizing the operation procedure of a new machine, it was conventionally necessary to create the manual manually, but by using this service, a manual can be automatically created simply by recording a video. As a result, work efficiency is greatly improved, and even first-time users can easily understand the operation procedure. Thus, the manual creation system can efficiently provide easy-to-understand manuals by analyzing videos, generating images and descriptive text, creating manuals, and providing support with a chatbot.

The manual creation system according to the embodiment includes an analysis unit, a generation unit, a creation unit, and a support unit. The analysis unit analyzes a video. The analysis unit, for example, analyzes the content of the video using generative AI. The generative AI can analyze each frame of the video and detect specific objects or actions. For example, the analysis unit uses generative AI to detect specific operation procedures in the video and generate images and descriptive text corresponding to those procedures. The generation unit generates images and descriptive text based on the content of the video analyzed by the analysis unit. The generation unit, for example, generates images and descriptive text for each step using generative AI. The generative AI can generate images and descriptive text for each step based on the content of the video. For example, the generation unit uses generative AI to generate images and descriptive text corresponding to specific operation procedures in the video. The creation unit creates a manual based on the images and descriptive text generated by the generation unit. The creation unit, for example, creates a manual based on the generated images and descriptive text using generative AI. The generative AI can automatically determine the structure and format of the manual based on the generated images and descriptive text. For example, the creation unit uses generative AI to arrange the images and descriptive text for each step in order and create a manual that makes the operation procedure immediately understandable. The support unit provides a chatbot that responds to the manual created by the creation unit. The support unit, for example, uses AI so that when a user asks a question about the content of the manual, the chatbot provides an answer. The AI can provide appropriate answers to user questions. For example, the support unit uses AI to provide detailed explanations for questions about specific operation procedures. Thus, the manual creation system according to the embodiment can efficiently provide easy-to-understand manuals by analyzing videos, generating images and descriptive text, creating manuals, and providing support with a chatbot.

The analysis unit analyzes a video. The analysis unit, for example, analyzes the content of the video using generative AI. The generative AI can analyze each frame of the video and detect specific objects or actions. Specifically, the generative AI uses deep learning technology to individually analyze each frame in the video, taking into account continuity between frames, and detects specific operation procedures or important actions. For example, it can accurately recognize hand movements, tool usage, and changes on the screen in the video, and extract them as operation procedures. Furthermore, the generative AI uses natural language processing technology to extract information from audio or subtitles in the video, supplementing the understanding of operation procedures. As a result, the analysis unit can analyze the content of the video from multiple perspectives and accurately detect detailed operation procedures. The analysis unit also stores the analysis results in a database so that subsequent generation and creation units can easily access them. In this way, the analysis unit can efficiently and accurately analyze the content of the video and improve the overall system performance.

The generation unit generates images and descriptive text based on the content of the video analyzed by the analysis unit. The generation unit, for example, generates images and descriptive text for each step using generative AI. The generative AI can generate images and descriptive text for each step based on the content of the video. Specifically, the generative AI selects important frames for each step based on the operation procedures provided by the analysis unit and extracts them as images. Furthermore, the generative AI uses natural language generation technology to generate easy-to-understand descriptive text for each step's operation procedure. For example, the generative AI selects appropriate technical terms and expressions to concisely and clearly explain the content of the operation procedure, creating descriptive text in a format that is easy for users to understand. In addition, the generation unit centrally manages the generated images and descriptive text so that the subsequent creation unit can easily access them. In this way, the generation unit can efficiently and accurately generate images and descriptive text based on the information provided by the analysis unit and improve the overall system performance.

The creation unit creates a manual based on the images and descriptive text generated by the generation unit. The creation unit, for example, creates a manual based on the generated images and descriptive text using generative AI. The generative AI can automatically determine the structure and format of the manual based on the generated images and descriptive text. Specifically, the generative AI arranges the images and descriptive text for each step in order to create a manual that makes the operation procedure immediately understandable. Furthermore, the generative AI can optimize the layout and design of the manual according to the user's needs and objectives. For example, the generative AI can highlight important information or appropriately place charts and icons so that the user can quickly understand specific operation procedures. In addition, the creation unit saves the generated manual in digital format so that users can easily access it. In this way, the creation unit can efficiently and accurately create a manual based on the information provided by the generation unit and improve the overall system performance.

The support unit provides a chatbot that responds to the manual created by the creation unit. The support unit, for example, uses AI so that when a user asks a question about the content of the manual, the chatbot provides an answer. The AI can provide appropriate answers to user questions. Specifically, the AI uses natural language processing technology to understand user questions and generate appropriate answers. For example, when a user asks about a specific operation procedure, the AI can provide a detailed explanation or additional images related to that procedure. In addition, the AI analyzes the user's question history and prepares answers to frequently asked questions in advance, enabling prompt responses. Furthermore, the support unit collects user feedback and can continuously improve the accuracy and response speed of the chatbot's answers. In this way, the support unit can provide prompt and appropriate support to users and improve the overall system performance.

The analysis unit can analyze the content of a video by means of generative AI. The analysis unit, for example, analyzes each frame of the video and detects specific objects or actions using generative AI. The generative AI can generate images and descriptive text for each step based on the content of the video. For example, the analysis unit uses generative AI to detect specific operation procedures in the video and generate images and descriptive text corresponding to those procedures. In this way, by using generative AI, the content of the video can be efficiently analyzed. The generative AI, for example, analyzes the content of the video using deep learning algorithms. The generative AI learns from a large amount of video data and can provide highly accurate analysis results. For example, the generative AI can accurately detect specific objects or actions in the video and analyze their content. In this way, the analysis unit can efficiently analyze the content of the video by using generative AI.

The generation unit can generate images and descriptive text for each step by means of generative AI. The generation unit, for example, generates images and descriptive text for each step using generative AI. The generative AI can generate images and descriptive text for each step based on the content of the video. For example, the generation unit uses generative AI to generate images and descriptive text corresponding to specific operation procedures in the video. In this way, by using generative AI, images and descriptive text for each step can be efficiently generated. The generative AI, for example, analyzes the content of the video using natural language processing technology and generates appropriate descriptive text. The generative AI learns from a large amount of text data and can generate highly accurate descriptive text. For example, the generative AI can generate highly accurate descriptive text corresponding to specific operation procedures in the video. In this way, the generation unit can efficiently generate images and descriptive text for each step by using generative AI.

The creation unit can create a manual based on the images and descriptive text generated by generative AI. The creation unit, for example, creates a manual based on the generated images and descriptive text using generative AI. The generative AI can automatically determine the structure and format of the manual based on the generated images and descriptive text. For example, the creation unit uses generative AI to arrange the images and descriptive text for each step in order to create a manual that makes the operation procedure immediately understandable. In this way, by using generative AI, the manual can be efficiently created. The generative AI, for example, creates a manual based on the generated images and descriptive text using machine learning algorithms. The generative AI learns from a large amount of manual data and can create highly accurate manuals. For example, the generative AI arranges the images and descriptive text for each step in the optimal order to create an easy-to-understand manual. In this way, the creation unit can efficiently create a manual by using generative AI.

The support unit can provide answers by a chatbot when a user asks a question about the content of the manual. The support unit, for example, uses AI so that when a user asks a question about the content of the manual, the chatbot provides an answer. The AI can provide appropriate answers to user questions. For example, the support unit uses AI to provide detailed explanations for questions about specific operation procedures. In this way, by using a chatbot, user questions can be answered promptly. The AI, for example, analyzes user questions using natural language processing technology and generates appropriate answers. The AI learns from a large amount of question data and can provide highly accurate answers. For example, the AI can promptly provide relevant information in response to user questions. In this way, the support unit can promptly answer user questions by using AI.

The support unit can perform version control by means of generative AI and always provide the latest manual. The support unit, for example, performs version control of the manual using generative AI. The generative AI can automatically track the change history of the manual and manage the latest version. For example, the support unit uses generative AI to automatically collect update information of the manual and provide the latest manual. In this way, by using generative AI, the latest manual can always be provided. The generative AI, for example, manages the change history of the manual using a version control system. The generative AI can automatically save each version of the manual and provide the latest version as needed. For example, the generative AI collects update information of the manual in real time and provides the latest manual. In this way, the support unit can always provide the latest manual by using generative AI.

The analysis unit can detect specific actions or gestures during video analysis and detail the analysis results based on the detection. The analysis unit, for example, detects hand movements in the video using generative AI and analyzes the operation procedure in detail. The generative AI can detect specific actions or gestures based on the content of the video. For example, the analysis unit uses generative AI to detect facial expressions in the video and analyze the user's intent. In addition, the analysis unit can detect body movements in the video using generative AI and analyze the workflow. In this way, by detecting specific actions or gestures, the analysis results can be detailed. The generative AI, for example, uses computer vision technology to accurately detect specific actions or gestures in the video. The generative AI learns from a large amount of video data and can perform highly accurate action detection. For example, the generative AI can accurately detect hand movements or facial expressions in the video and analyze their content. In this way, the analysis unit can detect specific actions or gestures during video analysis and detail the analysis results by using generative AI.

The analysis unit can analyze background sounds and environmental sounds during video analysis and add information about the working environment. The analysis unit, for example, analyzes background sounds in the video using generative AI and evaluates the noise level of the working environment. The generative AI can analyze background sounds and environmental sounds based on the content of the video. For example, the analysis unit uses generative AI to analyze environmental sounds in the video and identify the work location. In addition, the analysis unit can analyze speech in the video using generative AI and extract the content of work instructions. In this way, by analyzing background sounds and environmental sounds, information about the working environment can be added. The generative AI, for example, uses speech recognition technology to accurately analyze background sounds and environmental sounds in the video. The generative AI learns from a large amount of audio data and can perform highly accurate audio analysis. For example, the generative AI can accurately analyze background sounds and environmental sounds in the video and evaluate their content. In this way, the analysis unit can analyze background sounds and environmental sounds during video analysis and add information about the working environment by using generative AI.

The analysis unit can refer to a user's past video analysis history during video analysis to improve analysis accuracy. The analysis unit, for example, refers to the user's past video analysis history using generative AI. The generative AI can optimize the analysis algorithm based on past analysis history. For example, the analysis unit uses generative AI to refer to the user's past analysis history and improve accuracy when analyzing similar videos. In addition, the analysis unit can optimize the analysis algorithm based on the user's past analysis results using generative AI. Furthermore, the analysis unit can analyze the user's past analysis history using generative AI to grasp analysis trends. In this way, by referring to past analysis history, analysis accuracy can be improved. The generative AI, for example, learns the user's past analysis history using machine learning algorithms. The generative AI can optimize the analysis algorithm based on a large amount of analysis history data. For example, the generative AI can analyze the user's past analysis history with high accuracy and improve analysis accuracy. In this way, the analysis unit can refer to a user's past video analysis history during video analysis to improve analysis accuracy by using generative AI.

The analysis unit can customize analysis results by considering a user's geographic location information during video analysis. The analysis unit, for example, considers the user's geographic location information using generative AI. The generative AI can customize analysis results based on the user's location information. For example, the analysis unit uses generative AI to analyze region-specific work procedures based on the user's geographic location information. In addition, the analysis unit can refer to the user's location information using generative AI and provide analysis results tailored to the region's language and culture. Furthermore, the analysis unit can analyze the region's environmental conditions based on the user's location information using generative AI. In this way, by considering geographic location information, analysis results can be customized. The generative AI, for example, obtains the user's geographic location information using location information services. The generative AI can optimize analysis results based on location information data. For example, the generative AI can accurately obtain the user's location information and customize analysis results based on that information. In this way, the analysis unit can customize analysis results by considering a user's geographic location information during video analysis by using generative AI.

The generation unit can generate images and descriptive text for emphasizing specific scenes or important steps in the video during generation. The generation unit, for example, generates images and descriptive text that emphasize important operation steps in the video using generative AI. The generative AI can emphasize specific scenes or important steps based on the content of the video. For example, the generation unit uses generative AI to capture specific scenes in the video and add detailed descriptive text. In addition, the generation unit can highlight important points in the video visually using generative AI. In this way, by emphasizing specific scenes or important steps, easy-to-understand manuals can be provided. The generative AI, for example, uses computer vision technology to accurately detect specific scenes or important steps in the video. The generative AI learns from a large amount of video data and can perform highly accurate scene detection. For example, the generative AI can accurately detect important operation steps in the video and emphasize their content. In this way, the generation unit can generate images and descriptive text for emphasizing specific scenes or important steps in the video during generation by using generative AI.

The generation unit can generate descriptive text including interactive elements based on the content of the video during generation. The generation unit, for example, generates descriptive text including interactive elements (for example, clickable links or buttons) based on the content of the video using generative AI. The generative AI can generate descriptive text including interactive elements based on the content of the video. For example, the generation unit uses generative AI to add links to specific operation steps in the video and provide detailed explanations. In addition, the generation unit can place buttons on important scenes in the video using generative AI to display related information. Furthermore, the generation unit can add interactive elements to each step in the video using generative AI so that users can access detailed information. In this way, by generating descriptive text including interactive elements, users can easily access detailed information. The generative AI, for example, uses web technology to generate descriptive text including interactive elements. The generative AI learns from a large amount of web data and can generate highly accurate interactive elements. For example, the generative AI can accurately add links or buttons to specific operation steps in the video and make the content interactive. In this way, the generation unit can generate descriptive text including interactive elements based on the content of the video during generation by using generative AI.

The generation unit can customize the generated content by referring to a user's past manual usage history during generation. The generation unit, for example, refers to the user's past manual usage history using generative AI. The generative AI can customize the generated content based on past usage history. For example, the generation unit uses generative AI to refer to the user's past manual usage history and customize similar content for generation. In addition, the generation unit can generate optimal descriptive text and images based on the user's past usage history using generative AI. Furthermore, the generation unit can analyze the user's past usage history using generative AI to generate a manual tailored to the user's preferences. In this way, by referring to past usage history, the generated content can be customized. The generative AI, for example, learns the user's past usage history using machine learning algorithms. The generative AI can optimize the generated content based on a large amount of usage history data. For example, the generative AI can analyze the user's past usage history with high accuracy and customize the generated content. In this way, the generation unit can customize the generated content by referring to a user's past manual usage history during generation by using generative AI.

The generation unit can generate optimal images and descriptive text by considering a user's device information during generation. The generation unit, for example, considers the user's device information using generative AI. The generative AI can generate optimal images and descriptive text based on the user's device information. For example, the generation unit uses generative AI to generate images and descriptive text tailored to the screen size of the user's device. In addition, the generation unit can generate images and descriptive text in the optimal format by considering the performance of the user's device using generative AI. Furthermore, the generation unit can refer to the user's device usage status using generative AI to select the optimal display method. In this way, by considering device information, optimal images and descriptive text can be generated. The generative AI, for example, obtains the user's device information using device information services. The generative AI can optimize the generated content based on device information data. For example, the generative AI can accurately obtain the user's device information and generate optimal images and descriptive text based on that information. In this way, the generation unit can generate optimal images and descriptive text by considering a user's device information during generation by using generative AI.

The creation unit can reflect improvements to the manual by referring to a user's past feedback during manual creation. The creation unit, for example, refers to the user's past feedback using generative AI. The generative AI can reflect improvements to the manual based on past feedback. For example, the creation unit uses generative AI to refer to the user's past feedback and create a manual reflecting the improvements. In addition, the creation unit can optimize the content of the manual based on the user's feedback using generative AI. Furthermore, the creation unit can analyze the user's past feedback using generative AI to create a manual tailored to the user's needs. In this way, by referring to past feedback, improvements to the manual can be reflected. The generative AI, for example, learns the user's past feedback using machine learning algorithms. The generative AI can optimize improvements to the manual based on a large amount of feedback data. For example, the generative AI can analyze the user's past feedback with high accuracy and reflect improvements to the manual. In this way, the creation unit can reflect improvements to the manual by referring to a user's past feedback during manual creation by using generative AI.

The creation unit can use a customized template based on the content of the video during manual creation. The creation unit, for example, uses a customized template based on the content of the video using generative AI. The generative AI can select the optimal template based on the content of the video. For example, the creation unit uses generative AI to analyze the content of the video, select the optimal template, and create a manual. In addition, the creation unit can use templates corresponding to each step in the video using generative AI to create a manual. Furthermore, the creation unit can generate a customized template based on the content of the video using generative AI and create a manual. In this way, by using a customized template, a more appropriate manual can be provided. The generative AI, for example, generates a customized template based on the content of the video using a template generation algorithm. The generative AI learns from a large amount of template data and can generate highly accurate templates. For example, the generative AI can accurately analyze the content of the video and generate the optimal template based on that content. In this way, the creation unit can use a customized template based on the content of the video during manual creation by using generative AI.

The creation unit can create an optimal manual by considering a user's geographic location information during manual creation. The creation unit, for example, considers the user's geographic location information using generative AI. The generative AI can create an optimal manual based on the user's location information. For example, the creation unit uses generative AI to create a manual including region-specific work procedures based on the user's geographic location information. In addition, the creation unit can refer to the user's location information using generative AI and create a manual tailored to the region's language and culture. Furthermore, the creation unit can create a manual considering the region's environmental conditions based on the user's location information using generative AI. In this way, by considering geographic location information, an optimal manual can be created. The generative AI, for example, obtains the user's geographic location information using location information services. The generative AI can optimize the content of the manual based on location information data. For example, the generative AI can accurately obtain the user's location information and create an optimal manual based on that information. In this way, the creation unit can create an optimal manual by considering a user's geographic location information during manual creation by using generative AI.

The creation unit can analyze a user's social media activity during manual creation and include relevant information in the manual. The creation unit, for example, analyzes the user's social media activity using generative AI. The generative AI can include relevant information in the manual based on social media activity. For example, the creation unit uses generative AI to analyze the user's social media activity and reflect relevant information in the manual. In addition, the creation unit can refer to feedback on social media using generative AI and optimize the content of the manual. Furthermore, the creation unit can create a manual tailored to the user's preferences based on social media activity using generative AI. In this way, by analyzing social media activity, relevant information can be included in the manual. The generative AI, for example, analyzes the user's social media activity using social media analysis algorithms. The generative AI learns from a large amount of social media data and can perform highly accurate analysis. For example, the generative AI can analyze the user's social media activity with high accuracy and reflect that information in the manual. In this way, the creation unit can analyze a user's social media activity during manual creation and include relevant information in the manual by using generative AI. The support unit can provide an optimal answer by referring to the user's past question history when the chatbot provides an answer. The support unit, for example, refers to the user's past question history using generative AI. The generative AI can provide an optimal answer based on past question history. For example, the support unit uses generative AI to refer to the user's past question history and provide the optimal answer to similar questions. In addition, the support unit can improve the accuracy of answers based on the user's past question history using generative AI. Furthermore, the support unit can analyze the user's past question history using generative AI to provide answers tailored to the user's tendencies. In this way, by referring to past question history, optimal answers can be provided. The generative AI, for example, analyzes the user's past question history using question history analysis algorithms. The generative AI learns from a large amount of question history data and can perform highly accurate analysis. For example, the generative AI can analyze the user's past question history with high accuracy and provide the optimal answer based on that information. In this way, the support unit can provide an optimal answer by referring to the user's past question history when the chatbot provides an answer by using generative AI.

The support unit can provide a customized answer based on the user's current situation or environment when the chatbot provides an answer. The support unit, for example, analyzes the user's current situation or environment using generative AI. The generative AI can provide the optimal answer based on the user's situation or environment. For example, the support unit uses generative AI to analyze the user's current situation and provide the optimal answer. In addition, the support unit can refer to the user's environmental information using generative AI and provide an answer suitable for the environment. Furthermore, the support unit can provide a customized answer based on the user's current situation using generative AI. In this way, by providing a customized answer based on the current situation or environment, a more appropriate answer can be provided. The generative AI, for example, analyzes the user's current situation using situation analysis algorithms. The generative AI learns from a large amount of situation data and can perform highly accurate analysis. For example, the generative AI can analyze the user's current situation with high accuracy and provide the optimal answer based on that information. In this way, the support unit can provide a customized answer based on the user's current situation or environment when the chatbot provides an answer by using generative AI.

The support unit can provide an optimal answer by considering the user's geographic location information when the chatbot provides an answer. The support unit, for example, considers the user's geographic location information using generative AI. The generative AI can provide the optimal answer based on the user's location information. For example, the support unit uses generative AI to provide an answer including region-specific information based on the user's geographic location information. In addition, the support unit can refer to the user's location information using generative AI and provide answers tailored to the region's language and culture. Furthermore, the support unit can provide answers considering the region's environmental conditions based on the user's location information using generative AI. In this way, by considering geographic location information, optimal answers can be provided. The generative AI, for example, obtains the user's geographic location information using location information services. The generative AI can optimize the content of the answer based on location information data. For example, the generative AI can accurately obtain the user's location information and provide the optimal answer based on that information. In this way, the support unit can provide an optimal answer by considering the user's geographic location information when the chatbot provides an answer by using generative AI.

The support unit can provide relevant information by analyzing the user's social media activity when the chatbot provides an answer. The support unit, for example, analyzes the user's social media activity using generative AI. The generative AI can provide relevant information based on social media activity. For example, the support unit uses generative AI to analyze the user's social media activity and reflect relevant information in the answer. In addition, the support unit can refer to feedback on social media using generative AI and optimize the content of the answer. Furthermore, the support unit can provide answers tailored to the user's preferences based on social media activity using generative AI. In this way, by analyzing social media activity, relevant information can be provided. The generative AI, for example, analyzes the user's social media activity using social media analysis algorithms. The generative AI learns from a large amount of social media data and can perform highly accurate analysis. For example, the generative AI can analyze the user's social media activity with high accuracy and provide the optimal answer based on that information. In this way, the support unit can provide relevant information by analyzing the user's social media activity when the chatbot provides an answer by using generative AI.

The system according to the embodiment is not limited to the above-described examples and can be variously modified, for example, as follows.

The analysis unit can detect specific actions or gestures during video analysis and detail the analysis results based on the detection. For example, by using generative AI, hand movements in the video can be detected and the operation procedure can be analyzed in detail. In addition, facial expressions in the video can be detected and the user's intent can be analyzed. Furthermore, body movements in the video can be detected and the workflow can be analyzed. In this way, by detecting specific actions or gestures, the analysis results can be detailed.

The analysis unit can analyze background sounds and environmental sounds during video analysis and add information about the working environment. For example, by using generative AI, background sounds in the video can be analyzed and the noise level of the working environment can be evaluated. In addition, environmental sounds in the video can be analyzed to identify the work location. Furthermore, speech in the video can be analyzed to extract the content of work instructions. In this way, by analyzing background sounds and environmental sounds, information about the working environment can be added.

The analysis unit can refer to a user's past video analysis history during video analysis to improve analysis accuracy. For example, by using generative AI, the user's past analysis history can be referred to and the accuracy when analyzing similar videos can be improved. In addition, the analysis algorithm can be optimized based on the user's past analysis results. Furthermore, the user's past analysis history can be analyzed to grasp analysis trends. In this way, by referring to past analysis history, analysis accuracy can be improved.

The generation unit can generate images and descriptive text for emphasizing specific scenes or important steps in the video during generation. For example, by using generative AI, images and descriptive text that emphasize important operation steps in the video can be generated. In addition, specific scenes in the video can be captured and detailed descriptive text can be added. Furthermore, important points in the video can be highlighted and visually emphasized. In this way, by emphasizing specific scenes or important steps, easy-to-understand manuals can be provided.

The generation unit can generate descriptive text including interactive elements based on the content of the video during generation. For example, by using generative AI, descriptive text including interactive elements (for example, clickable links or buttons) based on the content of the video can be generated. In addition, links can be added to specific operation steps in the video to provide detailed explanations. Furthermore, buttons can be placed on important scenes in the video to display related information. In this way, by generating descriptive text including interactive elements, users can easily access detailed information.

The following is a brief description of the processing flow of Example 1 of the Embodiment.
Step 1: The analysis unit analyzes a video. The analysis unit uses generative AI to analyze the content of the video, analyzing each frame of the video to detect specific objects or actions. For example, specific operation procedures in the video are detected and images and descriptive text corresponding to those procedures are generated.
Step 2: The generation unit generates images and descriptive text based on the content of the video analyzed by the analysis unit. The generation unit uses generative AI to generate images and descriptive text for each step, generating images and descriptive text corresponding to specific operation procedures in the video.
Step 3: The creation unit creates a manual based on the images and descriptive text generated by the generation unit. The creation unit uses generative AI to automatically determine the structure and format of the manual based on the generated images and descriptive text, arranging the images and descriptive text for each step in order to create a manual that makes the operation procedure immediately understandable.
Step 4: The support unit provides a chatbot that responds to the manual created by the creation unit. The support unit uses AI so that when a user asks a question about the content of the manual, the chatbot provides an answer and provides a detailed explanation for questions about specific operation procedures.

### Example 2 of Embodiment

The manual creation system according to the embodiment of the present invention is a system that automatically creates a manual based on video-recorded data. This manual creation system uses generative AI to generate images and text, instantly creating a manual that is easy for anyone to understand. In addition, by providing a chatbot that responds to the manual, more detailed understanding can be obtained. The manual creation system according to the embodiment of the present invention is a system that automatically creates a manual based on video-recorded data. This system uses generative AI to generate images and text, instantly creating a manual that is easy for anyone to understand. Furthermore, by providing a chatbot that responds to the manual, more detailed understanding can be obtained. First, the user records a video. This video is input to the generative AI. The generative AI analyzes the content of the video and generates images and descriptive text for each step. For example, when a video of machine operation procedures is input to the generative AI, the generative AI generates images and descriptive text for each operation step. Next, a manual is automatically created based on the images and descriptive text generated by the generative AI. The generated manual is structured to be easy to understand even for first-time users. For example, the images and descriptive text for each step are arranged in order, making the operation procedure immediately understandable. Furthermore, the generated manual is provided with a chatbot. When the user asks a question about the content of the manual, the chatbot provides an answer. For example, if a question is asked about a specific operation procedure, the chatbot provides a detailed explanation of that procedure. With this mechanism, the man-hours required for manual creation are greatly reduced, and version control is also facilitated. Since the generative AI automatically creates the manual, the latest manual is always provided. In addition, since a chatbot is provided, answers to unclear points can be obtained immediately. For example, in the manufacturing industry, when manualizing the operation procedure of a new machine, it was conventionally necessary to create the manual manually, but by using this service, a manual can be automatically created simply by recording a video. As a result, work efficiency is greatly improved, and even first-time users can easily understand the operation procedure. Thus, the manual creation system can efficiently provide easy-to-understand manuals by analyzing videos, generating images and descriptive text, creating manuals, and providing support with a chatbot.

The manual creation system according to the embodiment includes an analysis unit, a generation unit, a creation unit, and a support unit. The analysis unit analyzes a video. The analysis unit, for example, analyzes the content of the video using generative AI. The generative AI can analyze each frame of the video and detect specific objects or actions. For example, the analysis unit uses generative AI to detect specific operation procedures in the video and generate images and descriptive text corresponding to those procedures. The generation unit generates images and descriptive text based on the content of the video analyzed by the analysis unit. The generation unit, for example, generates images and descriptive text for each step using generative AI. The generative AI can generate images and descriptive text for each step based on the content of the video. For example, the generation unit uses generative AI to generate images and descriptive text corresponding to specific operation procedures in the video. The creation unit creates a manual based on the images and descriptive text generated by the generation unit. The creation unit, for example, creates a manual based on the generated images and descriptive text using generative AI. The generative AI can automatically determine the structure and format of the manual based on the generated images and descriptive text. For example, the creation unit uses generative AI to arrange the images and descriptive text for each step in order and create a manual that makes the operation procedure immediately understandable. The support unit provides a chatbot that responds to the manual created by the creation unit. The support unit, for example, uses AI so that when a user asks a question about the content of the manual, the chatbot provides an answer. The AI can provide appropriate answers to user questions. For example, the support unit uses AI to provide detailed explanations for questions about specific operation procedures. Thus, the manual creation system according to the embodiment can efficiently provide easy-to-understand manuals by analyzing videos, generating images and descriptive text, creating manuals, and providing support with a chatbot.

The analysis unit analyzes a video. The analysis unit, for example, analyzes the content of the video using generative AI. The generative AI can analyze each frame of the video and detect specific objects or actions. Specifically, the generative AI uses deep learning technology to individually analyze each frame in the video, taking into account continuity between frames, and detects specific operation procedures or important actions. For example, it can accurately recognize hand movements, tool usage, and changes on the screen in the video, and extract them as operation procedures. Furthermore, the generative AI uses natural language processing technology to extract information from audio or subtitles in the video, supplementing the understanding of operation procedures. As a result, the analysis unit can analyze the content of the video from multiple perspectives and accurately detect detailed operation procedures. The analysis unit also stores the analysis results in a database so that subsequent generation and creation units can easily access them. In this way, the analysis unit can efficiently and accurately analyze the content of the video and improve the overall system performance.

The generation unit generates images and descriptive text based on the content of the video analyzed by the analysis unit. The generation unit, for example, generates images and descriptive text for each step using generative AI. The generative AI can generate images and descriptive text for each step based on the content of the video. Specifically, the generative AI selects important frames for each step based on the operation procedures provided by the analysis unit and extracts them as images. Furthermore, the generative AI uses natural language generation technology to generate easy-to-understand descriptive text for each step's operation procedure. For example, the generative AI selects appropriate technical terms and expressions to concisely and clearly explain the content of the operation procedure, creating descriptive text in a format that is easy for users to understand. In addition, the generation unit centrally manages the generated images and descriptive text so that the subsequent creation unit can easily access them. In this way, the generation unit can efficiently and accurately generate images and descriptive text based on the information provided by the analysis unit and improve the overall system performance.

The creation unit creates a manual based on the images and descriptive text generated by the generation unit. The creation unit, for example, creates a manual based on the generated images and descriptive text using generative AI. The generative AI can automatically determine the structure and format of the manual based on the generated images and descriptive text. Specifically, the generative AI arranges the images and descriptive text for each step in order to create a manual that makes the operation procedure immediately understandable. Furthermore, the generative AI can optimize the layout and design of the manual according to the user's needs and objectives. For example, the generative AI can highlight important information or appropriately place charts and icons so that the user can quickly understand specific operation procedures. In addition, the creation unit saves the generated manual in digital format so that users can easily access it. In this way, the creation unit can efficiently and accurately create a manual based on the information provided by the generation unit and improve the overall system performance.

The support unit provides a chatbot that responds to the manual created by the creation unit. The support unit, for example, uses AI so that when a user asks a question about the content of the manual, the chatbot provides an answer. The AI can provide appropriate answers to user questions. Specifically, the AI uses natural language processing technology to understand user questions and generate appropriate answers. For example, when a user asks about a specific operation procedure, the AI can provide a detailed explanation or additional images related to that procedure. In addition, the AI analyzes the user's question history and prepares answers to frequently asked questions in advance, enabling prompt responses. Furthermore, the support unit collects user feedback and can continuously improve the accuracy and response speed of the chatbot's answers. In this way, the support unit can provide prompt and appropriate support to users and improve the overall system performance.

The analysis unit can analyze the content of a video by means of generative AI. The analysis unit, for example, analyzes each frame of the video and detects specific objects or actions using generative AI. The generative AI can generate images and descriptive text for each step based on the content of the video. For example, the analysis unit uses generative AI to detect specific operation procedures in the video and generate images and descriptive text corresponding to those procedures. In this way, by using generative AI, the content of the video can be efficiently analyzed. The generative AI, for example, analyzes the content of the video using deep learning algorithms. The generative AI learns from a large amount of video data and can provide highly accurate analysis results. For example, the generative AI can accurately detect specific objects or actions in the video and analyze their content. In this way, the analysis unit can efficiently analyze the content of the video by using generative AI.

The generation unit can generate images and descriptive text for each step by means of generative AI. The generation unit, for example, generates images and descriptive text for each step using generative AI. The generative AI can generate images and descriptive text for each step based on the content of the video. For example, the generation unit uses generative AI to generate images and descriptive text corresponding to specific operation procedures in the video. In this way, by using generative AI, images and descriptive text for each step can be efficiently generated. The generative AI, for example, analyzes the content of the video using natural language processing technology and generates appropriate descriptive text. The generative AI learns from a large amount of text data and can generate highly accurate descriptive text. For example, the generative AI can generate highly accurate descriptive text corresponding to specific operation procedures in the video. In this way, the generation unit can efficiently generate images and descriptive text for each step by using generative AI.

The creation unit can create a manual based on the images and descriptive text generated by generative AI. The creation unit, for example, creates a manual based on the generated images and descriptive text using generative AI. The generative AI can automatically determine the structure and format of the manual based on the generated images and descriptive text. For example, the creation unit uses generative AI to arrange the images and descriptive text for each step in order to create a manual that makes the operation procedure immediately understandable. In this way, by using generative AI, the manual can be efficiently created. The generative AI, for example, creates a manual based on the generated images and descriptive text using machine learning algorithms. The generative AI learns from a large amount of manual data and can create highly accurate manuals. For example, the generative AI arranges the images and descriptive text for each step in the optimal order to create an easy-to-understand manual. In this way, the creation unit can efficiently create a manual by using generative AI.

The support unit can provide answers by a chatbot when a user asks a question about the content of the manual. The support unit, for example, uses AI so that when a user asks a question about the content of the manual, the chatbot provides an answer. The AI can provide appropriate answers to user questions. For example, the support unit uses AI to provide detailed explanations for questions about specific operation procedures. In this way, by using a chatbot, user questions can be answered promptly. The AI, for example, analyzes user questions using natural language processing technology and generates appropriate answers. The AI learns from a large amount of question data and can provide highly accurate answers. For example, the AI can promptly provide relevant information in response to user questions. In this way, the support unit can promptly answer user questions by using AI.

The support unit can perform version control by means of generative AI and always provide the latest manual. The support unit, for example, performs version control of the manual using generative AI. The generative AI can automatically track the change history of the manual and manage the latest version. For example, the support unit uses generative AI to automatically collect update information of the manual and provide the latest manual. In this way, by using generative AI, the latest manual can always be provided. The generative AI, for example, manages the change history of the manual using a version control system. The generative AI can automatically save each version of the manual and provide the latest version as needed. For example, the generative AI collects update information of the manual in real time and provides the latest manual. In this way, the support unit can always provide the latest manual by using generative AI.

The analysis unit can estimate a user's emotion and adjust the video analysis method based on the estimated emotion. The analysis unit, for example, estimates the user's emotion using generative AI. The generative AI can analyze the user's facial expressions and voice to estimate emotion. For example, if the user is nervous, the analysis unit uses generative AI to perform the video analysis slowly and provide detailed explanations. In addition, if the user is relaxed, the analysis unit can perform the video analysis quickly and provide concise explanations. Furthermore, if the user is in a hurry, the analysis unit can focus the analysis on important points. In this way, by adjusting the video analysis method according to the user's emotion, more appropriate analysis results can be provided. Emotion estimation is realized, for example, by using an emotion engine or a generative AI with emotion estimation functions. The generative AI may be a text generative AI (e.g., LLM) or a multimodal generative AI, but is not limited to such examples. Some or all of the above-described processing in the analysis unit may be performed using AI or may be performed without using AI. For example, the analysis unit can input the user's facial expression data to the generative AI and have the generative AI perform the emotion estimation.

The analysis unit can detect specific actions or gestures during video analysis and detail the analysis results based on the detection. The analysis unit, for example, detects hand movements in the video using generative AI and analyzes the operation procedure in detail. The generative AI can detect specific actions or gestures based on the content of the video. For example, the analysis unit uses generative AI to detect facial expressions in the video and analyze the user's intent. In addition, the analysis unit can detect body movements in the video using generative AI and analyze the workflow. In this way, by detecting specific actions or gestures, the analysis results can be detailed. The generative AI, for example, uses computer vision technology to accurately detect specific actions or gestures in the video. The generative AI learns from a large amount of video data and can perform highly accurate action detection. For example, the generative AI can accurately detect hand movements or facial expressions in the video and analyze their content. In this way, the analysis unit can detect specific actions or gestures during video analysis and detail the analysis results by using generative AI.

The analysis unit can analyze background sounds and environmental sounds during video analysis and add information about the working environment. The analysis unit, for example, analyzes background sounds in the video using generative AI and evaluates the noise level of the working environment. The generative AI can analyze background sounds and environmental sounds based on the content of the video. For example, the analysis unit uses generative AI to analyze environmental sounds in the video and identify the work location. In addition, the analysis unit can analyze speech in the video using generative AI and extract the content of work instructions. In this way, by analyzing background sounds and environmental sounds, information about the working environment can be added. The generative AI, for example, uses speech recognition technology to accurately analyze background sounds and environmental sounds in the video. The generative AI learns from a large amount of audio data and can perform highly accurate audio analysis. For example, the generative AI can accurately analyze background sounds and environmental sounds in the video and evaluate their content. In this way, the analysis unit can analyze background sounds and environmental sounds during video analysis and add information about the working environment by using generative AI.

The analysis unit can estimate a user's emotion and determine the priority of analysis results based on the estimated emotion. The analysis unit, for example, estimates the user's emotion using generative AI. The generative AI can analyze the user's facial expressions and voice to estimate emotion. For example, if the user is feeling stressed, the analysis unit uses generative AI to preferentially display important analysis results. In addition, if the user is relaxed, the analysis unit can sequentially display detailed analysis results. Furthermore, if the user is in a hurry, the analysis unit can quickly display analysis results that focus on the main points. In this way, by determining the priority of analysis results according to the user's emotion, important information can be preferentially provided. Emotion estimation is realized, for example, by using an emotion engine or a generative AI with emotion estimation functions. The generative AI may be a text generative AI (e.g., LLM) or a multimodal generative AI, but is not limited to such examples. Some or all of the above-described processing in the analysis unit may be performed using AI or may be performed without using AI. For example, the analysis unit can input the user's facial expression data to the generative AI and have the generative AI perform the emotion estimation.

The analysis unit can refer to a user's past video analysis history during video analysis to improve analysis accuracy. The analysis unit, for example, refers to the user's past video analysis history using generative AI. The generative AI can optimize the analysis algorithm based on past analysis history. For example, the analysis unit uses generative AI to refer to the user's past analysis history and improve accuracy when analyzing similar videos. In addition, the analysis unit can optimize the analysis algorithm based on the user's past analysis results using generative AI. Furthermore, the analysis unit can analyze the user's past analysis history using generative AI to grasp analysis trends. In this way, by referring to past analysis history, analysis accuracy can be improved. The generative AI, for example, learns the user's past analysis history using machine learning algorithms. The generative AI can optimize the analysis algorithm based on a large amount of analysis history data. For example, the generative AI can analyze the user's past analysis history with high accuracy and improve analysis accuracy. In this way, the analysis unit can refer to a user's past video analysis history during video analysis to improve analysis accuracy by using generative AI.

The analysis unit can customize analysis results by considering a user's geographic location information during video analysis. The analysis unit, for example, considers the user's geographic location information using generative AI. The generative AI can customize analysis results based on the user's location information. For example, the analysis unit uses generative AI to analyze region-specific work procedures based on the user's geographic location information. In addition, the analysis unit can refer to the user's location information using generative AI and provide analysis results tailored to the region's language and culture. Furthermore, the analysis unit can analyze the region's environmental conditions based on the user's location information using generative AI. In this way, by considering geographic location information, analysis results can be customized. The generative AI, for example, obtains the user's geographic location information using location information services. The generative AI can optimize analysis results based on location information data. For example, the generative AI can accurately obtain the user's location information and customize analysis results based on that information. In this way, the analysis unit can customize analysis results by considering a user's geographic location information during video analysis by using generative AI.

The generation unit can estimate a user's emotion and adjust the expression method of the images and descriptive text to be generated based on the estimated emotion. The generation unit, for example, estimates the user's emotion using generative AI. The generative AI can analyze the user's facial expressions and voice to estimate emotion. For example, if the user is nervous, the generation unit uses generative AI to generate simple and highly visible images and descriptive text. In addition, if the user is relaxed, the generation unit can generate detailed and colorful images and descriptive text. Furthermore, if the user is in a hurry, the generation unit can generate short images and descriptive text that focus on the main points. In this way, by adjusting the expression method of the images and descriptive text according to the user's emotion, a more appropriate manual can be provided. Emotion estimation is realized, for example, by using an emotion engine or a generative AI with emotion estimation functions. The generative AI may be a text generative AI (e.g., LLM) or a multimodal generative AI, but is not limited to such examples. Some or all of the above-described processing in the generation unit may be performed using AI or may be performed without using AI. For example, the generation unit can input the user's facial expression data to the generative AI and have the generative AI perform the emotion estimation.

The generation unit can generate images and descriptive text for emphasizing specific scenes or important steps in the video during generation. The generation unit, for example, generates images and descriptive text that emphasize important operation steps in the video using generative AI. The generative AI can emphasize specific scenes or important steps based on the content of the video. For example, the generation unit uses generative AI to capture specific scenes in the video and add detailed descriptive text. In addition, the generation unit can highlight important points in the video visually using generative AI. In this way, by emphasizing specific scenes or important steps, easy-to-understand manuals can be provided. The generative AI, for example, uses computer vision technology to accurately detect specific scenes or important steps in the video. The generative AI learns from a large amount of video data and can perform highly accurate scene detection. For example, the generative AI can accurately detect important operation steps in the video and emphasize their content. In this way, the generation unit can generate images and descriptive text for emphasizing specific scenes or important steps in the video during generation by using generative AI.

The generation unit can generate descriptive text including interactive elements based on the content of the video during generation. The generation unit, for example, generates descriptive text including interactive elements (for example, clickable links or buttons) based on the content of the video using generative AI. The generative AI can generate descriptive text including interactive elements based on the content of the video. For example, the generation unit uses generative AI to add links to specific operation steps in the video and provide detailed explanations. In addition, the generation unit can place buttons on important scenes in the video using generative AI to display related information. Furthermore, the generation unit can add interactive elements to each step in the video using generative AI so that users can access detailed information. In this way, by generating descriptive text including interactive elements, users can easily access detailed information. The generative AI, for example, uses web technology to generate descriptive text including interactive elements. The generative AI learns from a large amount of web data and can generate highly accurate interactive elements. For example, the generative AI can accurately add links or buttons to specific operation steps in the video and make the content interactive. In this way, the generation unit can generate descriptive text including interactive elements based on the content of the video during generation by using generative AI.

The generation unit can estimate a user's emotion and adjust the length of the images and descriptive text to be generated based on the estimated emotion. The generation unit, for example, estimates the user's emotion using generative AI. The generative AI can analyze the user's facial expressions and voice to estimate emotion. For example, if the user is in a hurry, the generation unit uses generative AI to generate short and concise images and descriptive text. In addition, if the user is relaxed, the generation unit can generate detailed images and descriptive text. Furthermore, if the user is excited, the generation unit can generate images and descriptive text with visually stimulating effects. In this way, by adjusting the length of the images and descriptive text according to the user's emotion, a more appropriate manual can be provided. Emotion estimation is realized, for example, by using an emotion engine or a generative AI with emotion estimation functions. The generative AI may be a text generative AI (e.g., LLM) or a multimodal generative AI, but is not limited to such examples. Some or all of the above-described processing in the generation unit may be performed using AI or may be performed without using AI. For example, the generation unit can input the user's facial expression data to the generative AI and have the generative AI perform the emotion estimation.

The generation unit can customize the generated content by referring to a user's past manual usage history during generation. The generation unit, for example, refers to the user's past manual usage history using generative AI. The generative AI can customize the generated content based on past usage history. For example, the generation unit uses generative AI to refer to the user's past manual usage history and customize similar content for generation. In addition, the generation unit can generate optimal descriptive text and images based on the user's past usage history using generative AI. Furthermore, the generation unit can analyze the user's past usage history using generative AI to generate a manual tailored to the user's preferences. In this way, by referring to past usage history, the generated content can be customized. The generative AI, for example, learns the user's past usage history using machine learning algorithms. The generative AI can optimize the generated content based on a large amount of usage history data. For example, the generative AI can analyze the user's past usage history with high accuracy and customize the generated content. In this way, the generation unit can customize the generated content by referring to a user's past manual usage history during generation by using generative AI.

The generation unit can generate optimal images and descriptive text by considering a user's device information during generation. The generation unit, for example, considers the user's device information using generative AI. The generative AI can generate optimal images and descriptive text based on the user's device information. For example, the generation unit uses generative AI to generate images and descriptive text tailored to the screen size of the user's device. In addition, the generation unit can generate images and descriptive text in the optimal format by considering the performance of the user's device using generative AI. Furthermore, the generation unit can refer to the user's device usage status using generative AI to select the optimal display method. In this way, by considering device information, optimal images and descriptive text can be generated. The generative AI, for example, obtains the user's device information using device information services. The generative AI can optimize the generated content based on device information data. For example, the generative AI can accurately obtain the user's device information and generate optimal images and descriptive text based on that information. In this way, the generation unit can generate optimal images and descriptive text by considering a user's device information during generation by using generative AI.

The creation unit can estimate a user's emotion and adjust the method of structuring the manual based on the estimated emotion. The creation unit, for example, estimates the user's emotion using generative AI. The generative AI can analyze the user's facial expressions and voice to estimate emotion. For example, if the user is nervous, the creation unit uses generative AI to create a simple and highly visible manual. In addition, if the user is relaxed, the creation unit can create a detailed and colorful manual. Furthermore, if the user is in a hurry, the creation unit can create a short manual that focuses on the main points. In this way, by adjusting the method of structuring the manual according to the user's emotion, a more appropriate manual can be provided. Emotion estimation is realized, for example, by using an emotion engine or a generative AI with emotion estimation functions. The generative AI may be a text generative AI (e.g., LLM) or a multimodal generative AI, but is not limited to such examples. Some or all of the above-described processing in the creation unit may be performed using AI or may be performed without using AI. For example, the creation unit can input the user's facial expression data to the generative AI and have the generative AI perform the emotion estimation.

The creation unit can reflect improvements to the manual by referring to a user's past feedback during manual creation. The creation unit, for example, refers to the user's past feedback using generative AI. The generative AI can reflect improvements to the manual based on past feedback. For example, the creation unit uses generative AI to refer to the user's past feedback and create a manual reflecting the improvements. In addition, the creation unit can optimize the content of the manual based on the user's feedback using generative AI. Furthermore, the creation unit can analyze the user's past feedback using generative AI to create a manual tailored to the user's needs. In this way, by referring to past feedback, improvements to the manual can be reflected. The generative AI, for example, learns the user's past feedback using machine learning algorithms. The generative AI can optimize improvements to the manual based on a large amount of feedback data. For example, the generative AI can analyze the user's past feedback with high accuracy and reflect improvements to the manual. In this way, the creation unit can reflect improvements to the manual by referring to a user's past feedback during manual creation by using generative AI.

The creation unit can use a customized template based on the content of the video during manual creation. The creation unit, for example, uses a customized template based on the content of the video using generative AI. The generative AI can select the optimal template based on the content of the video. For example, the creation unit uses generative AI to analyze the content of the video, select the optimal template, and create a manual. In addition, the creation unit can use templates corresponding to each step in the video using generative AI to create a manual. Furthermore, the creation unit can generate a customized template based on the content of the video using generative AI and create a manual. In this way, by using a customized template, a more appropriate manual can be provided. The generative AI, for example, generates a customized template based on the content of the video using a template generation algorithm. The generative AI learns from a large amount of template data and can generate highly accurate templates. For example, the generative AI can accurately analyze the content of the video and generate the optimal template based on that content. In this way, the creation unit can use a customized template based on the content of the video during manual creation by using generative AI.

The creation unit can estimate a user's emotion and determine the priority of the manual based on the estimated emotion. The creation unit, for example, estimates the user's emotion using generative AI. The generative AI can analyze the user's facial expressions and voice to estimate emotion. For example, if the user is feeling stressed, the creation unit uses generative AI to preferentially create important manuals. In addition, if the user is relaxed, the creation unit can sequentially create detailed manuals. Furthermore, if the user is in a hurry, the creation unit can quickly create manuals that focus on the main points. In this way, by determining the priority of the manual according to the user's emotion, important manuals can be preferentially provided. Emotion estimation is realized, for example, by using an emotion engine or a generative AI with emotion estimation functions. The generative AI may be a text generative AI (e.g., LLM) or a multimodal generative AI, but is not limited to such examples. Some or all of the above-described processing in the creation unit may be performed using AI or may be performed without using AI. For example, the creation unit can input the user's facial expression data to the generative AI and have the generative AI perform the emotion estimation.

The creation unit can create an optimal manual by considering a user's geographic location information during manual creation. The creation unit, for example, considers the user's geographic location information using generative AI. The generative AI can create an optimal manual based on the user's location information. For example, the creation unit uses generative AI to create a manual including region-specific work procedures based on the user's geographic location information. In addition, the creation unit can refer to the user's location information using generative AI and create a manual tailored to the region's language and culture. Furthermore, the creation unit can create a manual considering the region's environmental conditions based on the user's location information using generative AI. In this way, by considering geographic location information, an optimal manual can be created. The generative AI, for example, obtains the user's geographic location information using location information services. The generative AI can optimize the content of the manual based on location information data. For example, the generative AI can accurately obtain the user's location information and create an optimal manual based on that information. In this way, the creation unit can create an optimal manual by considering a user's geographic location information during manual creation by using generative AI.

The creation unit can analyze a user's social media activity during manual creation and include relevant information in the manual. The creation unit, for example, analyzes the user's social media activity using generative AI. The generative AI can include relevant information in the manual based on social media activity. For example, the creation unit uses generative AI to analyze the user's social media activity and reflect relevant information in the manual. In addition, the creation unit can refer to feedback on social media using generative AI and optimize the content of the manual. Furthermore, the creation unit can create a manual tailored to the user's preferences based on social media activity using generative AI. In this way, by analyzing social media activity, relevant information can be included in the manual. The generative AI, for example, analyzes the user's social media activity using social media analysis algorithms. The generative AI learns from a large amount of social media data and can perform highly accurate analysis. For example, the generative AI can analyze the user's social media activity with high accuracy and reflect that information in the manual. In this way, the creation unit can analyze a user's social media activity during manual creation and include relevant information in the manual by using generative AI.

The support unit can estimate a user's emotion and adjust the response method of the chatbot based on the estimated emotion. The support unit, for example, estimates the user's emotion using generative AI. The generative AI can analyze the user's facial expressions and voice to estimate emotion. For example, if the user is nervous, the support unit uses generative AI so that the chatbot provides answers in a calm tone. In addition, if the user is relaxed, the support unit can have the chatbot provide answers in a friendly tone. Furthermore, if the user is in a hurry, the support unit can have the chatbot provide quick and concise answers. In this way, by adjusting the response method of the chatbot according to the user's emotion, more appropriate answers can be provided. Emotion estimation is realized, for example, by using an emotion engine or a generative AI with emotion estimation functions. The generative AI may be a text generative AI (e.g., LLM) or a multimodal generative AI, but is not limited to such examples. Some or all of the above-described processing in the support unit may be performed using AI or may be performed without using AI. For example, the support unit can input the user's facial expression data to the generative AI and have the generative AI perform the emotion estimation.

The support unit can provide an optimal answer by referring to the user's past question history when the chatbot provides an answer. The support unit, for example, refers to the user's past question history using generative AI. The generative AI can provide an optimal answer based on past question history. For example, the support unit uses generative AI to refer to the user's past question history and provide the optimal answer to similar questions. In addition, the support unit can improve the accuracy of answers based on the user's past question history using generative AI. Furthermore, the support unit can analyze the user's past question history using generative AI to provide answers tailored to the user's tendencies. In this way, by referring to past question history, optimal answers can be provided. The generative AI, for example, analyzes the user's past question history using question history analysis algorithms. The generative AI learns from a large amount of question history data and can perform highly accurate analysis. For example, the generative AI can analyze the user's past question history with high accuracy and provide the optimal answer based on that information. In this way, the support unit can provide an optimal answer by referring to the user's past question history when the chatbot provides an answer by using generative AI.

The support unit can provide a customized answer based on the user's current situation or environment when the chatbot provides an answer. The support unit, for example, analyzes the user's current situation or environment using generative AI. The generative AI can provide the optimal answer based on the user's situation or environment. For example, the support unit uses generative AI to analyze the user's current situation and provide the optimal answer. In addition, the support unit can refer to the user's environmental information using generative AI and provide an answer suitable for the environment. Furthermore, the support unit can provide a customized answer based on the user's current situation using generative AI. In this way, by providing a customized answer based on the current situation or environment, a more appropriate answer can be provided. The generative AI, for example, analyzes the user's current situation using situation analysis algorithms. The generative AI learns from a large amount of situation data and can perform highly accurate analysis. For example, the generative AI can analyze the user's current situation with high accuracy and provide the optimal answer based on that information. In this way, the support unit can provide a customized answer based on the user's current situation or environment when the chatbot provides an answer by using generative AI.

The support unit can estimate a user's emotion and determine the priority of the chatbot's answers based on the estimated emotion. The support unit, for example, estimates the user's emotion using generative AI. The generative AI can analyze the user's facial expressions and voice to estimate emotion. For example, if the user is feeling stressed, the support unit uses generative AI so that the chatbot preferentially provides important answers. In addition, if the user is relaxed, the support unit can have the chatbot sequentially provide detailed answers. Furthermore, if the user is in a hurry, the support unit can have the chatbot quickly provide answers that focus on the main points. In this way, by determining the priority of answers according to the user's emotion, important answers can be preferentially provided. Emotion estimation is realized, for example, by using an emotion engine or a generative AI with emotion estimation functions. The generative AI may be a text generative AI (e.g., LLM) or a multimodal generative AI, but is not limited to such examples. Some or all of the above-described processing in the support unit may be performed using AI or may be performed without using AI. For example, the support unit can input the user's facial expression data to the generative AI and have the generative AI perform the emotion estimation.

The support unit can provide an optimal answer by considering the user's geographic location information when the chatbot provides an answer. The support unit, for example, considers the user's geographic location information using generative AI. The generative AI can provide the optimal answer based on the user's location information. For example, the support unit uses generative AI to provide an answer including region-specific information based on the user's geographic location information. In addition, the support unit can refer to the user's location information using generative AI and provide answers tailored to the region's language and culture. Furthermore, the support unit can provide answers considering the region's environmental conditions based on the user's location information using generative AI. In this way, by considering geographic location information, optimal answers can be provided. The generative AI, for example, obtains the user's geographic location information using location information services. The generative AI can optimize the content of the answer based on location information data. For example, the generative AI can accurately obtain the user's location information and provide the optimal answer based on that information. In this way, the support unit can provide an optimal answer by considering the user's geographic location information when the chatbot provides an answer by using generative AI.

The support unit can provide relevant information by analyzing the user's social media activity when the chatbot provides an answer. The support unit, for example, analyzes the user's social media activity using generative AI. The generative AI can provide relevant information based on social media activity. For example, the support unit uses generative AI to analyze the user's social media activity and reflect relevant information in the answer. In addition, the support unit can refer to feedback on social media using generative AI and optimize the content of the answer. Furthermore, the support unit can provide answers tailored to the user's preferences based on social media activity using generative AI. In this way, by analyzing social media activity, relevant information can be provided. The generative AI, for example, analyzes the user's social media activity using social media analysis algorithms. The generative AI learns from a large amount of social media data and can perform highly accurate analysis. For example, the generative AI can analyze the user's social media activity with high accuracy and provide the optimal answer based on that information. In this way, the support unit can provide relevant information by analyzing the user's social media activity when the chatbot provides an answer by using generative AI.

The system according to the embodiment is not limited to the above-described examples and can be variously modified, for example, as follows.

The analysis unit can estimate a user's emotion and adjust the display method of analysis results based on the estimated emotion. For example, if the user is feeling stressed, the analysis unit emphasizes and concisely displays important information. In addition, if the user is relaxed, the analysis unit can sequentially display detailed information. Furthermore, if the user is in a hurry, the analysis unit can quickly display information that focuses on the main points. In this way, by adjusting the display method of analysis results according to the user's emotion, more appropriate information can be provided.

The generation unit can estimate a user's emotion and adjust the style of the images and descriptive text to be generated based on the estimated emotion. For example, if the user is nervous, the generation unit generates simple and highly visible images and descriptive text. In addition, if the user is relaxed, the generation unit can generate detailed and colorful images and descriptive text. Furthermore, if the user is in a hurry, the generation unit can generate short images and descriptive text that focus on the main points. In this way, by adjusting the style of the images and descriptive text according to the user's emotion, a more appropriate manual can be provided.

The creation unit can estimate a user's emotion and adjust the method of structuring the manual based on the estimated emotion. For example, if the user is nervous, the creation unit creates a simple and highly visible manual. In addition, if the user is relaxed, the creation unit can create a detailed and colorful manual. Furthermore, if the user is in a hurry, the creation unit can create a short manual that focuses on the main points. In this way, by adjusting the method of structuring the manual according to the user's emotion, a more appropriate manual can be provided.

The support unit can estimate a user's emotion and adjust the response method of the chatbot based on the estimated emotion. For example, if the user is nervous, the chatbot provides answers in a calm tone. In addition, if the user is relaxed, the chatbot can provide answers in a friendly tone. Furthermore, if the user is in a hurry, the chatbot can provide quick and concise answers. In this way, by adjusting the response method of the chatbot according to the user's emotion, more appropriate answers can be provided.

The analysis unit can estimate a user's emotion and determine the priority of analysis results based on the estimated emotion. For example, if the user is feeling stressed, the analysis unit preferentially displays important analysis results. In addition, if the user is relaxed, the analysis unit can sequentially display detailed analysis results. Furthermore, if the user is in a hurry, the analysis unit can quickly display analysis results that focus on the main points. In this way, by determining the priority of analysis results according to the user's emotion, important information can be preferentially provided.

The analysis unit can detect specific actions or gestures during video analysis and detail the analysis results based on the detection. For example, by using generative AI, hand movements in the video can be detected and the operation procedure can be analyzed in detail. In addition, facial expressions in the video can be detected and the user's intent can be analyzed. Furthermore, body movements in the video can be detected and the workflow can be analyzed. In this way, by detecting specific actions or gestures, the analysis results can be detailed.

The analysis unit can analyze background sounds and environmental sounds during video analysis and add information about the working environment. For example, by using generative AI, background sounds in the video can be analyzed and the noise level of the working environment can be evaluated. In addition, environmental sounds in the video can be analyzed to identify the work location. Furthermore, speech in the video can be analyzed to extract the content of work instructions. In this way, by analyzing background sounds and environmental sounds, information about the working environment can be added.

The analysis unit can refer to a user's past video analysis history during video analysis to improve analysis accuracy. For example, by using generative AI, the user's past analysis history can be referred to and the accuracy when analyzing similar videos can be improved. In addition, the analysis algorithm can be optimized based on the user's past analysis results. Furthermore, the user's past analysis history can be analyzed to grasp analysis trends. In this way, by referring to past analysis history, analysis accuracy can be improved.

The generation unit can generate images and descriptive text for emphasizing specific scenes or important steps in the video during generation. For example, by using generative AI, images and descriptive text that emphasize important operation steps in the video can be generated. In addition, specific scenes in the video can be captured and detailed descriptive text can be added. Furthermore, important points in the video can be highlighted and visually emphasized. In this way, by emphasizing specific scenes or important steps, easy-to-understand manuals can be provided.

The generation unit can generate descriptive text including interactive elements based on the content of the video during generation. For example, by using generative AI, descriptive text including interactive elements (for example, clickable links or buttons) based on the content of the video can be generated. In addition, links can be added to specific operation steps in the video to provide detailed explanations. Furthermore, buttons can be placed on important scenes in the video to display related information. In this way, by generating descriptive text including interactive elements, users can easily access detailed information.

The following is a brief description of the processing flow of Example 2 of the Embodiment.
Step 1: The analysis unit analyzes a video. The analysis unit uses generative AI to analyze the content of the video, analyzing each frame of the video to detect specific objects or actions. For example, specific operation procedures in the video are detected and images and descriptive text corresponding to those procedures are generated.
Step 2: The generation unit generates images and descriptive text based on the content of the video analyzed by the analysis unit. The generation unit uses generative AI to generate images and descriptive text for each step, generating images and descriptive text corresponding to specific operation procedures in the video.
Step 3: The creation unit creates a manual based on the images and descriptive text generated by the generation unit. The creation unit uses generative AI to automatically determine the structure and format of the manual based on the generated images and descriptive text, arranging the images and descriptive text for each step in order to create a manual that makes the operation procedure immediately understandable.
Step 4: The support unit provides a chatbot that responds to the manual created by the creation unit. The support unit uses AI so that when a user asks a question about the content of the manual, the chatbot provides an answer and provides a detailed explanation for questions about specific operation procedures.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described analysis unit, generation unit, creation unit, and support unit is implemented by at least one of, for example, the smart device 14 and the data processing apparatus 12. For example, the analysis unit captures a video using the camera 42 of the smart device 14 and analyzes the content of the video by a specific processing unit 290 of the data processing apparatus 12. The generation unit generates images and descriptive text based on the content analyzed by the specific processing unit 290 of the data processing apparatus 12. The creation unit creates a manual based on the images and descriptive text generated by the specific processing unit 290 of the data processing apparatus 12. The support unit uses a chatbot provided by the control unit 46A of the smart device 14 to answer user questions. The correspondence between each unit and the device or control unit is not limited to the above examples and various modifications are possible.

### Second Embodiment

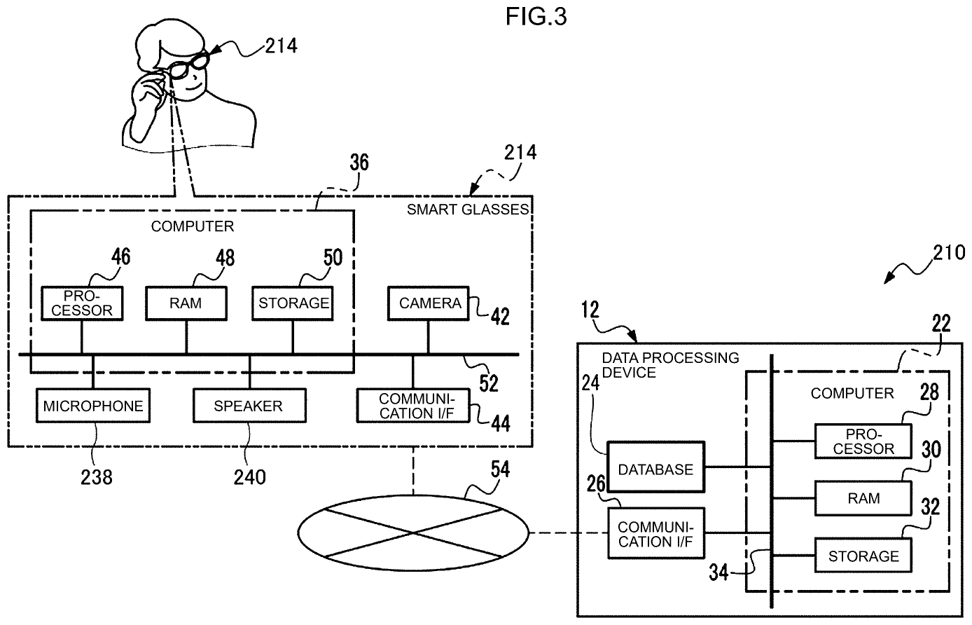

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

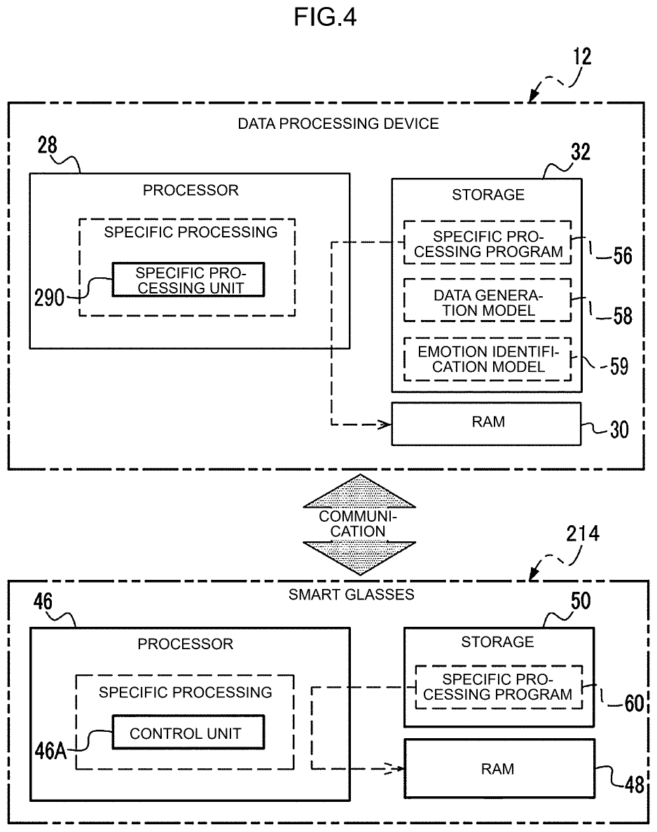

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described analysis unit, generation unit, creation unit, and support unit is implemented by at least one of, for example, the smart glasses 214 and the data processing apparatus 12. For example, the analysis unit captures a video using the camera 42 of the smart glasses 214 and analyzes the content of the video by a specific processing unit 290 of the data processing apparatus 12. The generation unit generates images and descriptive text based on the content analyzed by the specific processing unit 290 of the data processing apparatus 12. The creation unit creates a manual based on the images and descriptive text generated by the specific processing unit 290 of the data processing apparatus 12. The support unit uses a chatbot provided by the control unit 46A of the smart glasses 214 to answer user questions. The correspondence between each unit and the device or control unit is not limited to the above examples and various modifications are possible.

### Third Embodiment

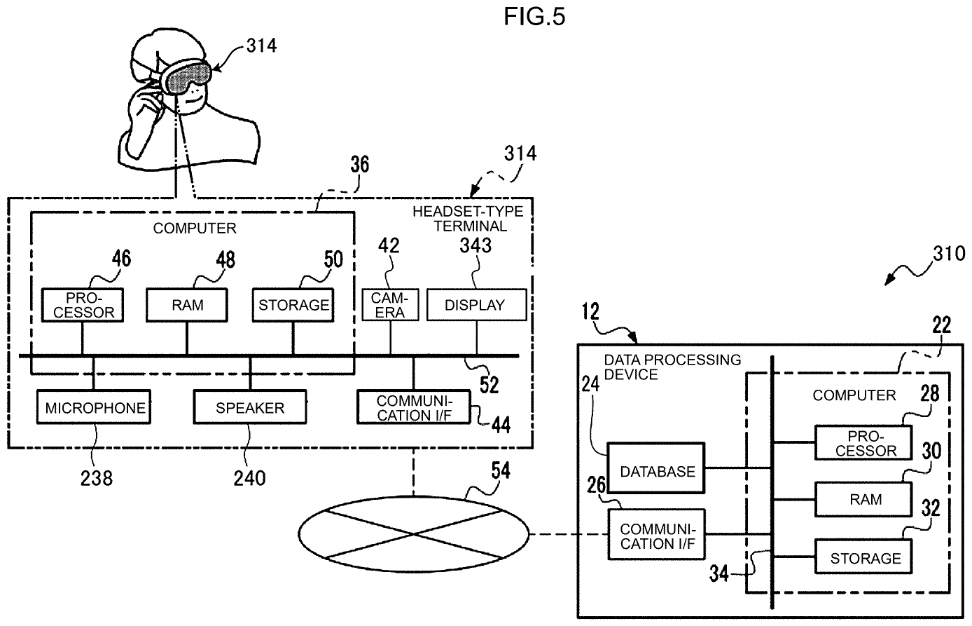

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

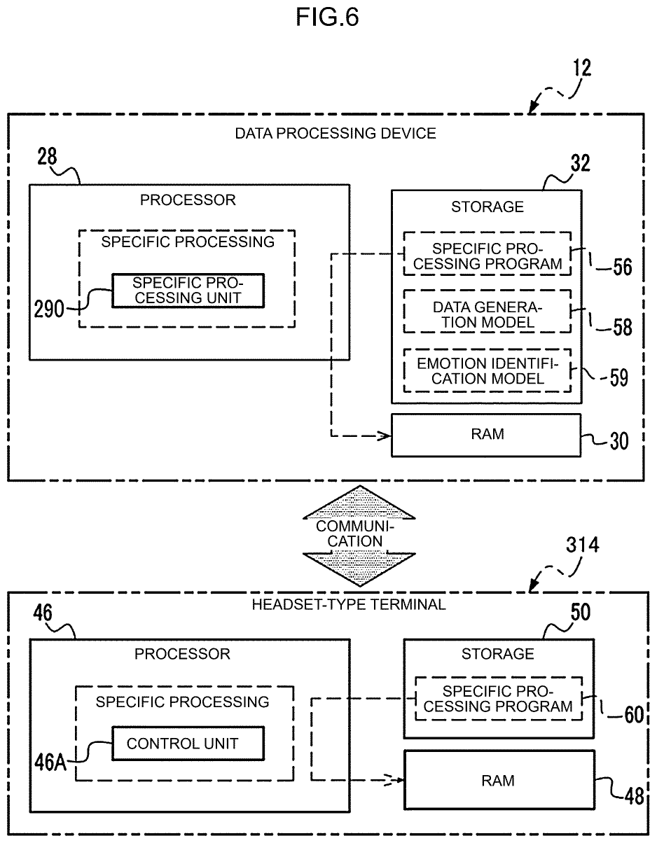

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described analysis unit, generation unit, creation unit, and support unit is implemented by at least one of, for example, the headset-type terminal 314 and the data processing apparatus 12. For example, the analysis unit captures a video using the camera 42 of the headset-type terminal 314 and analyzes the content of the video by a specific processing unit 290 of the data processing apparatus 12. The generation unit generates images and descriptive text based on the content analyzed by the specific processing unit 290 of the data processing apparatus 12. The creation unit creates a manual based on the images and descriptive text generated by the specific processing unit 290 of the data processing apparatus 12. The support unit uses a chatbot provided by the control unit 46A of the headset-type terminal 314 to answer user questions. The correspondence between each unit and the device or control unit is not limited to the above examples and various modifications are possible.

### Fourth Embodiment

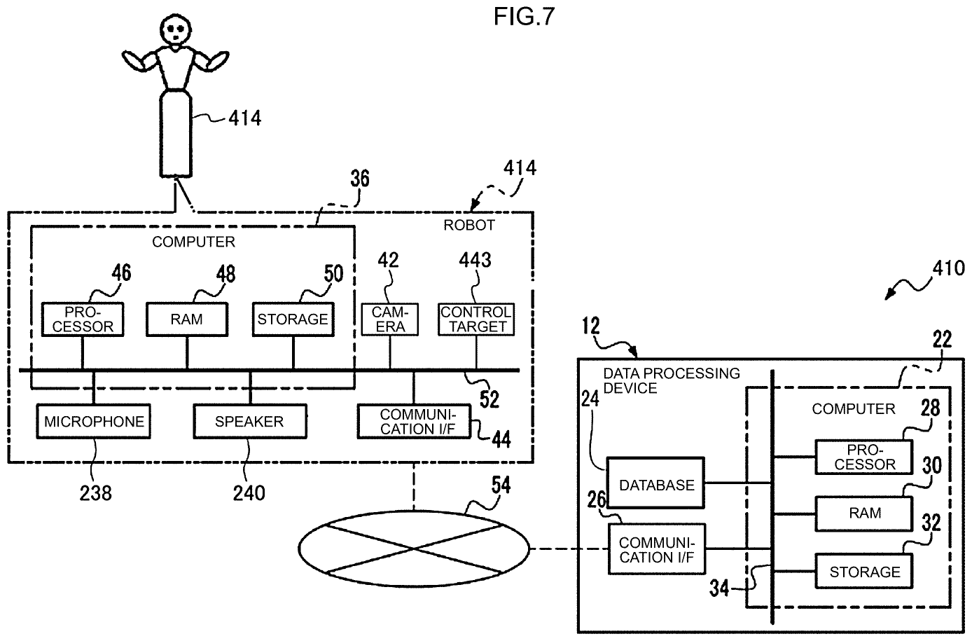

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

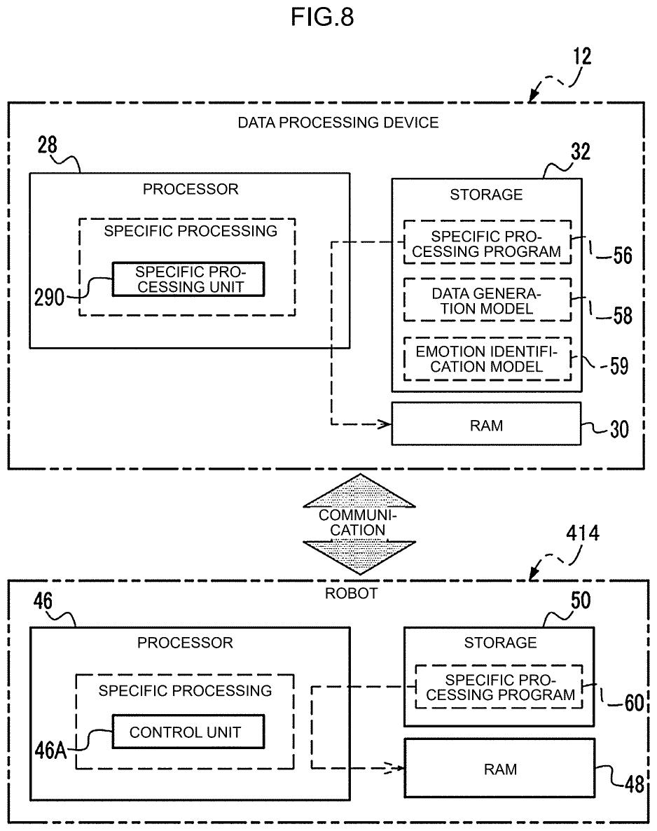

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described analysis unit, generation unit, creation unit, and support unit is implemented by at least one of, for example, the robot 414 and the data processing apparatus 12. For example, the analysis unit captures a video using the camera 42 of the robot 414 and analyzes the content of the video by a specific processing unit 290 of the data processing apparatus 12. The generation unit generates images and descriptive text based on the content analyzed by the specific processing unit 290 of the data processing apparatus 12. The creation unit creates a manual based on the images and descriptive text generated by the specific processing unit 290 of the data processing apparatus 12. The support unit uses a chatbot provided by the control unit 46A of the robot 414 to answer user questions. The correspondence between each unit and the device or control unit is not limited to the above examples and various modifications are possible.

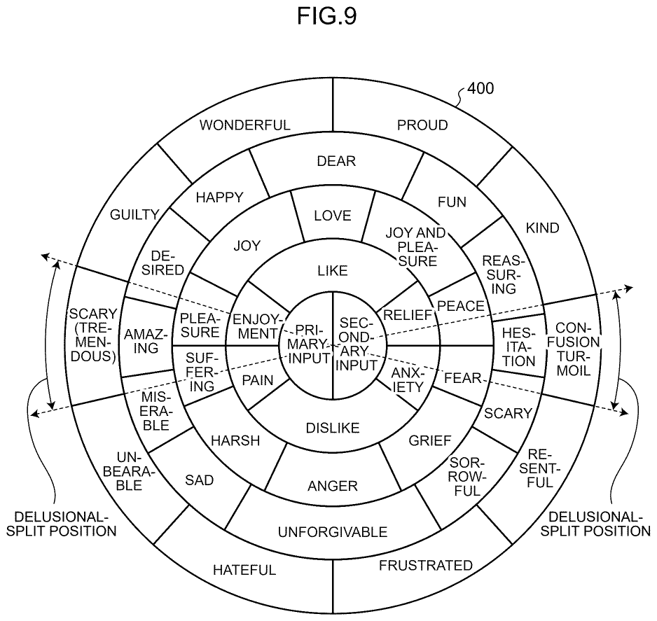

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

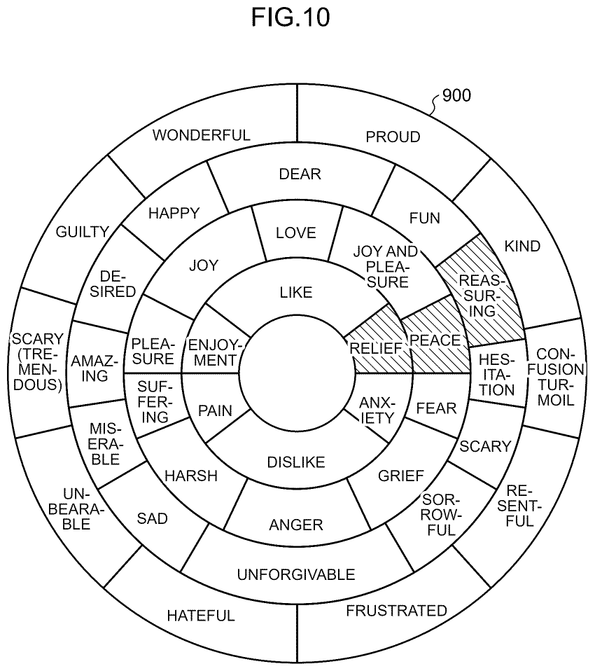

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
[Additional Note 1] A system including: an analysis unit configured to analyze a video; a generation unit configured to generate images and descriptive text based on the content of the video analyzed by the analysis unit; a creation unit configured to create a manual based on the images and descriptive text generated by the generation unit; and a support unit configured to provide a chatbot that responds to the manual created by the creation unit.
[Additional Note 2] The system according to Additional Note 1, wherein the analysis unit is configured to analyze the content of the video by means of a generative AI.
[Additional Note 3] The system according to Additional Note 1, wherein the generation unit is configured to generate images and descriptive text for each step by means of a generative AI.
[Additional Note 4] The system according to Additional Note 1, wherein the creation unit is configured to create a manual based on the images and descriptive text generated by means of a generative AI.
[Additional Note 5] The system according to Additional Note 1, wherein the support unit is configured such that when a user asks a question about the content of the manual, the chatbot provides an answer.
[Additional Note 6] The system according to Additional Note 1, wherein the support unit is configured to perform version control by means of a generative AI and always provide the latest manual.
[Additional Note 7] The system according to Additional Note 1, wherein the analysis unit is configured to estimate a user's emotion and adjust the video analysis method based on the estimated emotion.
[Additional Note 8] The system according to Additional Note 1, wherein the analysis unit is configured to detect specific actions or gestures during video analysis and to detail the analysis results based on the detection.
[Additional Note 9] The system according to Additional Note 1, wherein the analysis unit is configured to analyze background sounds and environmental sounds during video analysis and to add information about the working environment.
[Additional Note 10] The system according to Additional Note 1, wherein the analysis unit is configured to estimate a user's emotion and determine the priority of analysis results based on the estimated emotion.
[Additional Note 11] The system according to Additional Note 1, wherein the analysis unit is configured to refer to a user's past video analysis history during video analysis to improve analysis accuracy.
[Additional Note 12] The system according to Additional Note 1, wherein the analysis unit is configured to customize analysis results by considering a user's geographic location information during video analysis.
[Additional Note 13] The system according to Additional Note 1, wherein the generation unit is configured to estimate a user's emotion and adjust the expression method of the images and descriptive text to be generated based on the estimated emotion.
[Additional Note 14] The system according to Additional Note 1, wherein the generation unit is configured to generate images and descriptive text for emphasizing specific scenes or important steps in the video during generation.
[Additional Note 15] The system according to Additional Note 1, wherein the generation unit is configured to generate descriptive text including interactive elements based on the content of the video during generation.
[Additional Note 16] The system according to Additional Note 1, wherein the generation unit is configured to estimate a user's emotion and adjust the length of the images and descriptive text to be generated based on the estimated emotion.
[Additional Note 17] The system according to Additional Note 1, wherein the generation unit is configured to customize the generated content by referring to a user's past manual usage history during generation.
[Additional Note 18] The system according to Additional Note 1, wherein the generation unit is configured to generate optimal images and descriptive text by considering a user's device information during generation.
[Additional Note 19] The system according to Additional Note 1, wherein the creation unit is configured to estimate a user's emotion and adjust the method of structuring the manual based on the estimated emotion.
[Additional Note 20] The system according to Additional Note 1, wherein the creation unit is configured to reflect improvements to the manual by referring to a user's past feedback during manual creation.
[Additional Note 21] The system according to Additional Note 1, wherein the creation unit is configured to use a customized template based on the content of the video during manual creation.
[Additional Note 22] The system according to Additional Note 1, wherein the creation unit is configured to estimate a user's emotion and determine the priority of the manual based on the estimated emotion.
[Additional Note 23] The system according to Additional Note 1, wherein the creation unit is configured to create an optimal manual by considering a user's geographic location information during manual creation.
[Additional Note 24] The system according to Additional Note 1, wherein the creation unit is configured to analyze a user's social media activity during manual creation and include relevant information in the manual.
[Additional Note 25] The system according to Additional Note 1, wherein the support unit is configured to estimate a user's emotion and adjust the response method of the chatbot based on the estimated emotion.
[Additional Note 26] The system according to Additional Note 1, wherein the support unit is configured such that when the chatbot provides an answer, it refers to the user's past question history to provide an optimal answer.
[Additional Note 27] The system according to Additional Note 1, wherein the support unit is configured such that when the chatbot provides an answer, it provides a customized answer based on the user's current situation or environment.
[Additional Note 28] The system according to Additional Note 1, wherein the support unit is configured to estimate a user's emotion and determine the priority of the chatbot's answers based on the estimated emotion.
[Additional Note 29] The system according to Additional Note 1, wherein the support unit is configured such that when the chatbot provides an answer, it provides an optimal answer by considering the user's geographic location information.
[Additional Note 30] The system according to Additional Note 1, wherein the support unit is configured such that when the chatbot provides an answer, it analyzes the user's social media activity and provides relevant information.

What is claimed is:

1. A system comprising: an analysis unit configured to analyze a video; a generation unit configured to generate images and descriptive text based on the content of the video analyzed by the analysis unit; a creation unit configured to create a manual based on the images and descriptive text generated by the generation unit; and a support unit configured to provide a chatbot that responds to the manual created by the creation unit.

2. The system according to claim 1, wherein the analysis unit is configured to analyze the content of the video by means of a generative AI.

3. The system according to claim 1, wherein the generation unit is configured to generate images and descriptive text for each step by means of a generative AI.

4. The system according to claim 1, wherein the creation unit is configured to create a manual based on the images and descriptive text generated by means of a generative AI.

5. The system according to claim 1, wherein the support unit is configured such that when a user asks a question about the content of the manual, the chatbot provides an answer.

6. The system according to claim 1, wherein the support unit is configured to perform version control by means of a generative AI and always provide the latest manual.

7. The system according to claim 1, wherein the analysis unit is configured to estimate a user's emotion and adjust the video analysis method based on the estimated emotion.

8. The system according to claim 1, wherein the analysis unit is configured to detect specific actions or gestures during video analysis and to detail the analysis results based on the detection.
